(19) United States
(12) Patent Application Publication
(10) Pub. No.: US 2025/0192416 A1
(43) Pub. Date: Jun. 12, 2025

(54) MANUFACTURING METHOD OF RADIO FREQUENCY DEVICES

(71) Applicant: PEARFID SOCIETA' A RESPONSABILITA' LIMITATA SEMPLIFICATA, Modena (MO) (IT)

(72) Inventors: Silvio LOLLI, Castelnuovo Rangone (MO) (IT); Marcello LOLLI, Modena (MO) (IT); Claudio LOLLI, Castelnuovo Rangone (MO) (IT)

(21) Appl. No.: 18/840,786

(22) PCT Filed: Feb. 21, 2023
(86) PCT No.: PCT/IB2023/051568

§ 371 Date: Aug. 22, 2024

(30) Foreign Application Priority Data
Feb. 22, 2022 (IT) 102022000003290

(51) Int. Cl. H01Q 1/22; B60C 19/00; G06K 19/077; H01Q 1/38

(52) U.S. Cl. CPC H01Q 1/2241; B60C 19/00; G06K 19/07775; H01Q 1/38; B60C 2019/004

(57) ABSTRACT

Manufacturing method of radio frequency devices (15) comprising: •—at least one phase of providing at least one lattice layer (1) having a lattice shape and made of electrically insulating material; •—at least one phase of providing at least one electronic control device (5); •—at least one phase of attaching the control device (5) onto the lattice layer (1); •—at least one phase of providing at least one conductive body (3), made of electrically conductive material; •—at least one phase of attaching the conductive body (3) substantially lying on the lattice layer (1) to make at least one antenna (4) having a predefined shape and configured to be inductively coupled to the control device (5); •the phase of attaching the conductive body (3) and/or the phase of attaching the control device (5) by arranging the conductive body (3) and the at least one control device (5) in proximity to each other define at least one RFID transponder (6).

### TECHNICAL FIELD

The present invention relates to a manufacturing method of radio frequency devices.

### BACKGROUND ART

A variety of manufacturing methods of radio frequency devices are known.

In particular, there is a growing need to provide manufacturing methods of radio frequency devices which can be integrated within various types of products so as to enable radio frequency identification of the product and/or its characteristics.

However, radio frequency devices are substantially composed of an antenna and of a microchip, which are generally very delicate and whose integration with certain types of products to be identified can be particularly complex.

In fact, the conformation, size and/or materials used to make the antenna make it particularly susceptible to deformation and/or damage which can jeopardize the functionality of the radio frequency device.

In this regard, therefore, it is known to provide radio frequency devices with an appropriate backing layer, e.g. a plastic film, to which the antenna is attached so that the latter can maintain its conformation without being deformed and/or damaged.

Generally, in fact, it is known to manufacture the antenna from a metal foil that, once coupled to the backing layer, i.e., the plastic film, is machined directly on the latter, e.g., by chemical erosion processes.

This backing layer, however, further complicates the operations of integrating the radio frequency devices with the products to be identified.

The backing layer, given its overall dimensions, can in fact jeopardize the soundness of the product to be identified, thus creating discontinuities within the same and weakening the structure thereof.

In addition, the backing layer represents an additional material to be integrated with the products to be identified, which further complicates the integration operations.

At the same time, it is equally important that the operation of the radio frequency device be guaranteed for the entire life of the product to be identified even if that product undergoes heavy and intensive use in hostile environments.

Therefore, the device must have considerable resistance to mechanical stress and temperature without interfering with the characteristics of the product to be identified.

These requirements gain further importance if the radio frequency device is to be integrated directly within one or more target materials used in the manufacture of the product to be identified.

In this case, in fact, the radio frequency device must be embedded within a material, such as during the machining of the material itself, which is used to manufacture the finished product.

In addition, it frequently happens that the end user of this type of device wants to keep the characteristics of the target material secret and therefore further complicates the manufacture of radio frequency devices compatible with such material.

To remedy at least some of these drawbacks, manufacturing methods of radio frequency devices are known described in patent documents WO2019186066 and WO2016193457.

Specifically, the methods described by the aforementioned papers enable the manufacture of a radio frequency device comprising a radiating antenna, having a solenoid conformation, and a microchip, inserted within the coils of the solenoid and provided with a control antenna inductively coupled to the radiating antenna. In this way, the coils of the solenoid wrap around the microchip and constrain it firmly to the antenna.

These characteristics make the radio frequency devices described by the above documents particularly suitable for integration with products made of rubber, such as tires. In addition, these characteristics ensure that such devices will operate throughout the life of the products that integrate them, even when the latter are subjected to severe conditions of use.

However, this kind of method does have some drawbacks.

In particular, the radio frequency devices made by known methods have particularly bulky dimensions.

In fact, complex conformations of the radiating antenna, such as the solenoid antenna, inevitably give the device large overall dimensions that complicate the installation of the device and its integration with the target material and/or with the product to be identified.

In addition, known methods involve time-consuming and complicated machining operations to give such conformations to the radiating antenna, resulting in higher manufacturing costs of the device.

Again, the fact that the radiating antenna must allow for the retention of the microchip greatly limits the variety of shapes that the antenna itself can take and/or the materials that can be used to manufacture it, restricting the fields of application of this type of radio frequency devices.

These drawbacks significantly increase the production time and cost of the device and limit its fields of application.

### DESCRIPTION OF THE INVENTION

The main aim of the present invention is to devise a manufacturing method of radio frequency devices which are easily, conveniently and quickly embeddable within a wide variety of target materials.

A further object of the present invention is to devise a manufacturing method of radio frequency devices with particularly small overall dimensions compared with the devices of known type.

An additional object of the present invention is to devise a manufacturing method of radio frequency devices which allows one or more of the radio frequency device components to be manufactured in a wide variety of shapes, sizes and materials to implement radio frequency devices having shape, size and physical/mechanical characteristics suitable for a multitude of applications.

Another object of the present invention is to devise a manufacturing method of radio frequency devices which can overcome the aforementioned drawbacks of the prior art within the framework of a simple, rational, easy and effective to use as well as affordable solution.

The aforementioned objects are achieved by this manufacturing method of radio frequency devices having the characteristics of claim 1.

The aforementioned objects are achieved by this manufacturing system of radio frequency devices having the characteristics of claim 10.

The aforementioned objects are achieved by this radio frequency device having the characteristics of claim 15.

The aforementioned objects are achieved by this set of radio frequency devices having the characteristics of claim 17.

The aforementioned objects are achieved by this tire having the characteristics of claim 18.

### BRIEF DESCRIPTION OF THE DRAWINGS

Other characteristics and advantages of the present invention will become more apparent from the description of a preferred, but not exclusive, embodiment of a manufacturing method of radio frequency devices, illustrated by way of an indicative, yet non-limiting example in the attached tables of drawings in which:

FIG. 1 is an axonometric view of one embodiment of the device according to the invention;

FIG. 2 is an axonometric view of an additional embodiment of the device according to the invention;

FIG. 3 is an additional axonometric view of the device according to the invention;

FIG. 4 is a schematic view of the manufacturing system of radio frequency devices according to the invention;

FIG. 5 is an axonometric view of the tire according to the invention;

FIGS. 6 and 7 are schematic views of a possible embodiment of a component of the system shown in FIG. 4;

FIG. 8 is a schematic view of an additional embodiment of the manufacturing system of devices according to the invention.

### EMBODIMENTS OF THE INVENTION

With particular reference to these figures, reference numeral 1 globally indicates a manufacturing method of radio frequency devices.

The manufacturing method of radio frequency devices comprises:
at least one phase of providing at least one lattice layer 1 having a lattice conformation and made of electrically insulating material, the lattice layer 1 defining at least one attachment face 7;
at least one phase of providing at least one electronic control device 5;
at least one phase of attaching the control device onto the lattice layer 1;
at least one phase of providing at least one conductive body 3, made of electrically conductive material;
at least one phase of attaching the conductive body 3 substantially lying on the lattice layer 1 to manufacture at least one antenna 4 having a predefined shape and configured to be inductively coupled to the control device 5.

Preferably, the lattice layer 1 defines at least one attachment face 7.

In addition, the phase of attaching the control device 5 involves arranging the latter superficially resting on the attachment face 7.

In addition, the phase of attaching the conductive body 3 involves arranging the latter superficially resting on the attachment face 7.

Notably, the conductive body 3 is not intertwined or interwoven with the lattice layer.

Preferably, the conductive body 3 has substantially elongated conformation. Further embodiments of the process cannot however be ruled out, wherein the conductive body 3 may have different conformations, e.g. round, square or the like.

Specifically, the phase of attaching the conductive body 3 and/or the phase of attaching the control device 5 arrange the conductive body 3 and the control device 5 in the proximity to each other to define an RFID transponder 6.

Advantageously, the lattice layer 1 is a perforated body which defines a plurality of voids and solids defining an arrangement, preferably regular, with low density of solids, preferably so as to minimize the density of solids.

Specifically, the lattice layer 1 comprises a plurality of meshes, each defining at least one void, preferably in the form of a hole, passing through the same lattice layer from side to side.

Appropriately, the lattice layer 1 has mesh conformation, preferably with substantially square or rectangular meshes.

Further embodiments of the method cannot however be ruled out wherein the meshes of the lattice layer 1 have different shapes, such as triangular, circular or in the shape of other geometric shapes.

Preferably, the lattice layer 1 has a substantially planar conformation with very small thickness compared with its length and/or width.

Preferably, the lattice layer 1 has substantially sheet conformation.

Preferably, the lattice layer 1 is made of flexible material.

Preferably, the lattice layer 1 is made of material that is inextensible, or particularly resistant to extension, e.g. when subjected to tension. In this way, the lattice layer 1 is configured to be curved, but not to be extended and/or elongated.

Advantageously, the lattice layer 1 is made in a single body piece.

According to a preferred, but not exclusive, embodiment of the method, the lattice layer 1 is made of fiberglass.

Conveniently, the conductive body 3 is a body of elongated conformation, preferably filiform.

Preferably, the conductive body 3 is made of material of a type known to the experts in the field to manufacture particularly light and fine antennas, such as e.g. copper, steel, or the like.

The conductive body 3 is preferably made of electrically conductive flexible material so that it can be shaped to give the antenna a plurality of conformations.

Preferably, the conductive body 3 is of the type of a wire, e.g., steel, comprising a plurality of microfibers having diameters of substantially 15 microns that give the conductive body flexibility.

At the same time, the conductive body 3 is unable to maintain the shape given thereto independently. For example, the conductive body 3 is naturally flexible under the effect of its own weight.

Therefore, according to the invention, the conductive body 3 retains the conformation given thereto thanks to its attachment to the lattice layer 1.

Further embodiments of the method cannot however be ruled out, wherein the conductive body 3 maintains the conformation given thereto independently. In this regard, embodiments of the method cannot be ruled out wherein the conductive body 3 is substantially a wire, preferably made of steel, with a diameter substantially larger than 100 or 80 microns which allows the conductive body to maintain the shape.

Advantageously, the method comprises at least one phase of forming the conductive body 3, which involves deforming the conductive body 3 and giving it the predefined conformation. Appropriately, the phase of forming is carried out prior to the phase of attaching the conductive body 3.

According to the invention, the control device 5 is of the type of an RFID control device.

In particular, the control device 5 is of the type of a short-range RFID control device.

In fact, the control device 5 and the antenna 4 are inductively coupled together to define a long range RFID transponder.

Conveniently, the control device 5 comprises:
at least one control microchip 5a;
at least one control antenna 5b operatively connected to the control microchip 5a, the antenna 4 being configured to be inductively coupled to the control antenna 5b;
at least one protective enclosure 10, containing at least one of the control microchip 5a or the control antenna 5b.

In particular, at least one of the enclosure 10, the control microchip 5a and the control antenna 5b is shaped in a closed ring.

Advantageously, the ring conformation of at least one of the enclosure 10, the control microchip 5 and the control antenna 5b reduces interference with the product and/or material with which the radio frequency device 1 is integrated.

Preferably, the enclosure 10 is conformed substantially to protect only the control microchip 5a. In fact, the control antenna 5b may be made up of durable material that does not need protection. It cannot, however, be ruled out that the control antenna 5b may also be housed within the enclosure 10.

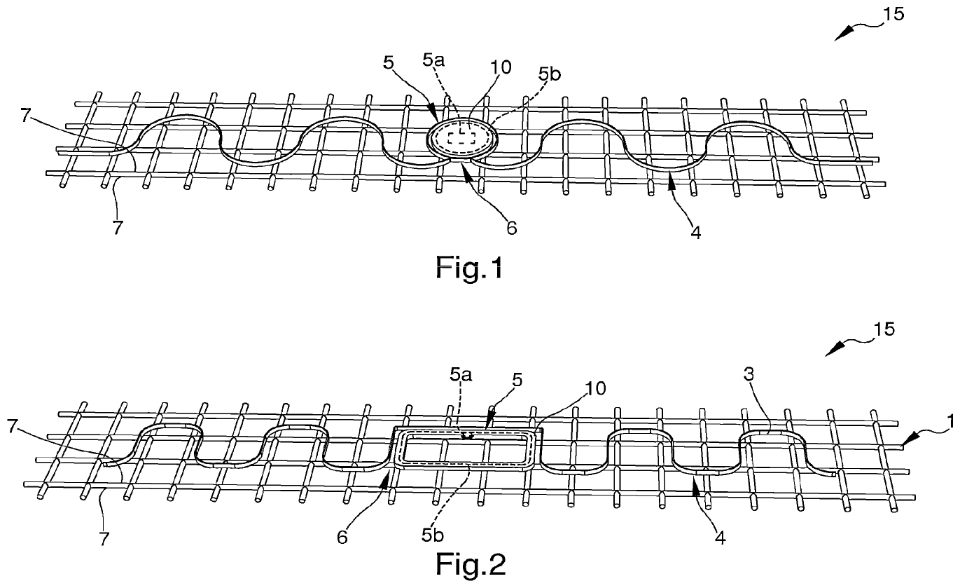

Another possible, but not exclusive, embodiment of the method is shown in FIG. 1, wherein the enclosure 10 has substantially full circular conformation.

Appropriately, the control device 5 has a particularly small thickness, preferably comparable to that of the conductive body 3. In this way, the phase of attaching the conductive body 3 and the control device 5 allows for a substantially flat RFID transponder 6. In other words, it can be assumed that the thickness of the RFID transponder 6 is particularly small compared with its width and/or length.

Similarly, the sum of the thicknesses of the RFID transponder 6 and of the lattice layer 1 is also particularly small compared with its length and/or width.

Preferably, the attachment face 7 has substantially flat conformation.

Advantageously, the phase of attaching the conductive body 3 involves a modeling step of the conductive body 3 adapted to give the predefined conformation to the antenna 4.

Preferably, the modeling step gives the antenna 4 a substantially plane wave conformation, as shown in FIGS. 1 and 2. Further embodiments of the method cannot however be ruled out wherein the modeling step gives the antenna 4 a different conformation, e.g. linear, curved or the like.

According to the invention, the phase of attaching the conductive body 3 involves an applying step of at least one adhesive on the lattice layer 1 so as to attach the position of the conductive body 3 on the same lattice layer 1 according to the predefined conformation of the antenna 4.

According to the invention, the phase of attaching the control device 5 involves an applying step of at least one adhesive on the lattice layer 1 so as to attach the position of the control device 5. In this way, the lattice layer 1 attaches the mutual position between the conductive body 3 and the control device 5, supporting them, and ensures the proper operation of the RFID transponder 6. Further embodiments of the method cannot however be ruled out, wherein the phase of attaching is carried out by ultrasound, radio frequency, heat sealing and the like.

Advantageously, the method comprises at least one phase of embedding the lattice layer 1 within an embedding body 8.

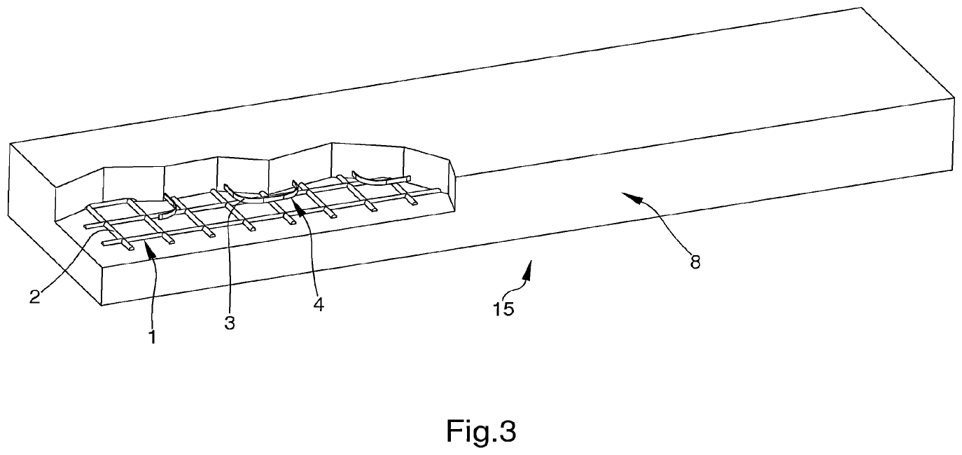

Appropriately, the phase of embedding involves the embedding body 8 passing through, at least partly, the holes in the lattice layer 1 to embed the RFID transponder 6, as shown in FIG. 3.

Preferably, embedding body 8 means a body made of a material having such characteristics so as to enable it, possibly with the aid of appropriate treatments, to embed other bodies, in this case the RFID transponder 6. In other words, through the phase of embedding, the RFID transponders 6 and the lattice layer 1 are substantially attached, e.g., drowned, within the embedding body 8.

In particular, the conformation of the lattice layer 1 allows the embedding body 8 to easily embed the RFID transponder 6 while minimizing the interference of the same lattice layer with the embedding body 8 and/or with the material of which the same is made. In other words, the characteristics of the lattice layer 1 allow the integration thereof within the embedding body 8 without adversely affecting the latter's characteristics, in this case the structural ones. In particular, the characteristics of the lattice layer 1 minimize the overall dimensions thereof and thus the interference with the embedding body 8.

At the same time, the lattice layer 1 enables attaching the position of the control device 5 and of the antenna 4, preventing excessive deformation of the latter and ensuring the operation of the RFID transponder 6.

Conveniently, the phase of embedding comprises at least the steps of:
providing at least one embedding layer 9a, 9b;
overlapping the embedding layer 9a, 9b and the lattice layer 1.

Preferably, following and/or during the overlapping step, the embedding layer 9a, 9b passes through, at least partly, the lattice layer 1 to at least partly embed it, thus defining at least partly the embedding body 8.

Advantageously, the embedding layer 9a, 9b passes through the meshes of the lattice layer 1, substantially drowning the latter within it. In this way, the embedding layer 9a, 9b defines at least partly a substantially solid embedding body 8 which is unaffected by the presence of the lattice layer 1. In fact, the embedding body 8 has substantially the same characteristics as it would have if the lattice layer 1 were not present.

Specifically, the overlapping step involves arranging the embedding layer 9a, 9b to cover, at least partly, an attachment face 7.

Preferably, the overlapping step involves arranging the lattice layer 1 and the embedding layer 9a, 9b facing in contact with each other so that the RFID transponder 6 is located between them.

Conveniently, the phase of embedding comprises at least one step of providing a first embedding layer 9a on which the lattice layer 1 is arranged and an additional embedding layer 9b. In addition, the phase of embedding comprises at least one overlapping step of the additional embedding layer 9b and of the lattice layer 1.

Specifically, the step of overlapping the additional embedding layer 9b and the lattice layer 1 involves arranging the additional embedding layer 9b to cover, at least partly, the other attachment face 7. In this way, the phase of embedding involves enclosing the lattice layer 1, substantially sandwiching it between two embedding layers 9a, 9b.

Specifically, the phase of embedding involves the embedding layers 9a, 9b passing through, at least partly, the lattice layer 1 and coupling together to embed one or more RFID transponders 6 and to manufacture the embedding body 8.

Preferably, the phase of embedding involves pressing the embedding layer 9a, 9b under pressure against the lattice layer 1 to facilitate embedding of the latter.

Appropriately, the phase of embedding involves pressing the embedding layers 9a, 9b under pressure against each other between which the lattice layer 1 is located.

In addition, it cannot be ruled out that the phase of embedding may comprise a phase of heating the embedding layers 9a, 9b which is carried out alternatively or in combination with pressing the same layers.

Preferably, the embedding layer 9a, 9b is made of at least partly moldable and/or deformable material, such as tire-making compounds or other similar materials.

It cannot, however, be ruled out that the phase of embedding may comprise a treatment step of the embedding layer 9a, 9b to make it at least partly moldable and/or deformable and to allow the embedding of one or more RFID transponders 6.

For example, it cannot be ruled out that the phase of embedding may comprise at least one of:
at least one casting step of at least one layer of embedding material;
at least one arrangement step of the lattice layer 1 above the layer of embedding material;
at least one casting step of an additional layer of embedding material on the lattice layer 1.

Specifically, in this case, the embedding material can be heated so that it can be cast and then cooled down around the lattice layer 1 and to manufacture the embedding body 8.

Appropriately, the embedding layers 9a, 9b are made of the same material.

Advantageously, the method comprises:
at least one phase of providing production means 30 of tires 31;
at least one phase of production of at least one tire 31 through the production means 30.

Specifically, the phase of embedding is carried out during the phase of production and the embedding body 8 coincides with the tire 31.

In this way, during the phase of production of the tire 31, the lattice layer 1 is embedded within the tire itself. In other words, the lattice layer 1 is embedded within the tire 31 through the steps required to carry out the phase of production of the tire 31. Specifically, the phase of production comprises at least one phase of providing at least one production body 33 for the production of the tire 31.

It cannot be ruled out that the production body 33 may be made from a tire compound or any body/material used by the production means 30 for the production of the tire 31. Advantageously, the production means 30 comprise machining means, not shown in the figures, of the production body 33 for the production of the tire 31.

Conveniently, the method comprises at least one phase of positioning the lattice layer 1 superficially resting on the production body 33 during the phase of production.

Preferably, the phase of positioning is of the type of a pick and place phase, e.g. carried out by means of suitable pick and place means.

Specifically, the phase of positioning involves arranging the lattice layer 1 directly in contact with the production body 33 during the phase of production.

Preferably, in the phase of positioning, the production body 33 is at least partly wrapped around a forming body 35 of the tire 31 adapted to at least partly give the same production body 33 the conformation of the tire 31.

Preferably, the phase of production involves overlapping by rolling up a plurality of production bodies 33. Specifically, the phase of positioning is carried out on one such body, prior to the overlapping thereof, so as to trap/embed the lattice layer 1 between the layers of production bodies.

Preferably, the lattice layer 1 is flexible but it maintains its conformation during the phase of production. In this way, the lattice layer can be laid/positioned directly on a production body which is subsequently covered by another production body, incorporating the lattice layer 1 between the same bodies.

Advantageously, the phase of production comprises a phase of molding, preferably by vulcanization, carried out after the phase of positioning and preferably after the phase of overlapping.

Specifically, during the phase of positioning, the production body 33 is accessible from the outside. At the end of the phase of production, on the other hand, the production body 33, which may have been machined, is arranged so that lattice layer 1 is made inaccessible from the outside.

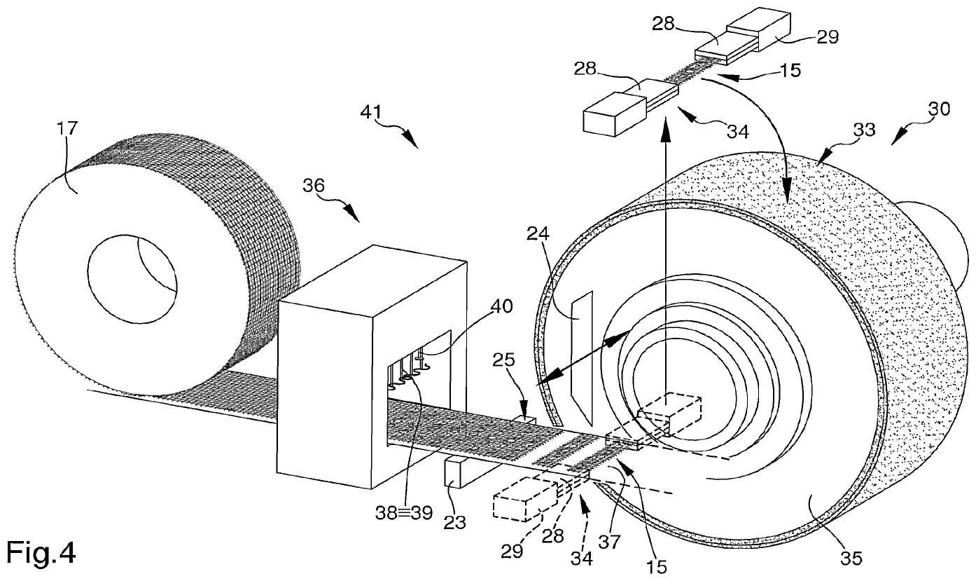

Conveniently, the embedding layer 9a, 9b provided coincides with the production body 33 and the overlapping step coincides with the phase of positioning, as shown in FIG. 4.

Specifically, the embedding layer 9a and the additional embedding layer 9b are defined by the production body 33 and by an additional production body 33, respectively.

It cannot also be ruled out that the method may comprise at least two phases of embedding, wherein in a first phase of embedding, the lattice layer 1 is embedded in an embedding body 8 different from the tire 31 and wherein the second phase of embedding is carried out subsequently to the placement on the production body 33 during the phase of production of the tire 31.

Conveniently, the method comprises at least one phase of repeating the phase of providing the conductive body 3, of the phase of providing the control device 5, of the phase of attaching the conductive body 3 and of the phase of attaching the control device 5 to make a plurality of RFID transponders 6 onto the lattice layer 1. In other words, the method involves manufacturing a plurality of RFID transponders 6 on the lattice layer 1.

Specifically, the RFID transponders 6 are arranged side by side, substantially in a row, along the extension of the lattice layer 1.

Preferably, the lattice layer 1 has a substantially ribbon-like conformation extending substantially longitudinally along a direction of development A. In addition, the antennas 4 of the RFID transponders 6 extend, substantially parallel to each other, transverse, preferably orthogonal, to the direction of development A, as shown in FIG. 4.

This expedient allows for possible subsequent coil and continuous machining operations.

This expedient also allows maximizing the number of RFID transponders supported by the lattice layer 1.

Conveniently, the method comprises at least one phase of wrapping the lattice layer 1 on itself on which the RFID transponders 6 are made. Thus, the phase of wrapping facilitates the storage of the same lattice layer and of the RFID transponders 6.

Preferably, the phase of wrapping is carried out around an appropriate backing, such as e.g. a spool, a roller or the like.

Conveniently, the method comprises at least one phase of cutting the lattice layer 1.

Specifically, the phase of cutting divides the lattice layer 1 into a plurality of separate lattice portions 11, each supporting at least one RFID transponder 6.

Advantageously, each portion of lattice layer 1 supports an individual RFID transponder 6. Thus, the method comprises a phase of positioning a corresponding tire 31 under production for each lattice layer 1 cut, e.g., to be arranged resting on a production body 33.

Preferably, the method comprises moving the lattice layer 1 on which the RFID transponders are made along a direction of movement B and carrying out at least one of the phase of cutting and the phase of positioning in succession and in continuity along the direction of movement B. In this way, the method allows a plurality of lattice portions 1 to be made in continuity, each supporting at least one RFID transponder 6 and each possibly embedded within a corresponding tire 31.

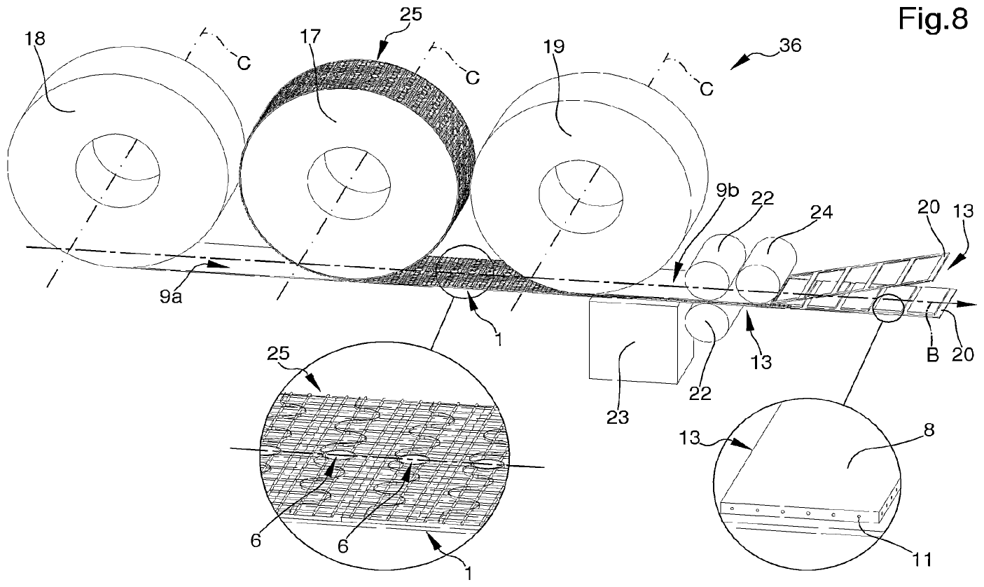

Further embodiments of the method cannot however be ruled out wherein the lattice layer 1 may be embedded in an embedding body 8 different from the production body 33 provided during the phase of production, e.g. as shown in FIG. 8.

Specifically, in this embodiment, the method comprises a phase of embedding in an embedding body 8, possibly embedding in turn, by means of an additional phase of embedding, of the production body 33 provided during the phase of production.

Preferably, in this embodiment, the phase of embedding is carried out following the phase of repetition, so that a plurality of RFID transponders 6 is embedded within an individual embedding body 8.

In particular, in this embodiment, the embedding layer 9a, 9b faces, preferably at least to size, the lattice layer 1.

In this way, the embedding layer 9a, 9b preferably completely covers the lattice layer 1.

Preferably, in this embodiment, the phase of cutting is carried out following the phase of embedding and involves also cutting the embedding body 8 to make a plurality of portions of lattice layer 1, each supporting at least one RFID transponder 6 and each embedded within a corresponding portion of the embedding body 8.

At the same time, the phase of cutting divides the embedding layer 9a, 9b into separate embedding portions 12 which are adapted to embed a respective lattice portion 11. In other words, the phase of cutting is carried out subsequently to the phase of embedding so as to make a plurality of blocks 13, each defined substantially by a stack of portions 11, 12 of the layers 1, 9a, 9b cut.

Preferably, according to this embodiment, the method comprises:
a phase of lamination of the lattice layer 1 with one or more embedding layers 9a, 9b, wherein the phase of lamination preferably comprises the phase of embedding;
a phase of die-cutting of the laminated lattice layer 1, wherein the phase of die-cutting preferably comprises the phase of cutting.

In this way, the method allows manufacturing a plurality of laminated lattice portions 11, each integrating at least one RFID transponder 6.

According to this embodiment, the method involves moving the lattice layer 1 on which the RFID transponders are made along a direction of movement B and carrying out the phase of embedding (or the phase of lamination) and the phase of cutting (or the phase of die-cutting) in succession and in continuity, along the direction of movement B.

In this way, the method allows manufacturing a plurality of lattice portions 1 in continuity, each supporting at least one RFID transponder 6, each embedded within a corresponding portion of the embedding body 8 and eventually embedded, as a result of a corresponding phase of positioning, within a corresponding tire 31.

According to a further aspect, the present invention relates to a manufacturing method of tires 31 which comprises at least one phase of performing the previously described manufacturing method of the radio frequency devices 15.

According to a further aspect, the present invention relates to a manufacturing system 36 of radio frequency devices 15, comprising:
supporting means 37 for supporting at least one lattice layer 1, made of electrically insulating material;
positioning means 38 for positioning at least one conductive body 3 substantially lying on the lattice layer 1 to make at least one antenna 4 having predefined conformation, the conductive body 3 being made of electrically conductive material.

Preferably, the lattice layer 1 defines at least one attachment face 7 and the positioning means 38 are adapted to arrange the conductive body 3 superficially resting on the attachment face 7.

Preferably, the manufacturing system 36 is employed to carry out the manufacturing method described above.

Preferably, the supporting means 37 are of the type of a resting surface on which the lattice layer 1 is arranged resting.

For example, the supporting means 37 are of the type of a conveyor belt or the like.

Preferably, the positioning means 38 are movable between at least one gripping configuration, wherein they hold the conductive body 3, and at least one release configuration, wherein they release the conductive body 3 by placing it on the attachment face 7.

Specifically, the positioning means 38 are configured to automatically position the conductive body 3 on the attachment face 7.

Advantageously, the manufacturing system 36 comprises forming means 39 operating on the conductive body 3 to deform it and give it the predefined conformation.

In more detail, the forming means 39 are configured to deform the conductive body 3 in an automated manner.

Preferably, the forming means 39 coincide with the positioning means 38.

Advantageously, the manufacturing system 36 comprises arrangement means 40 of at least one control device 5 on the lattice layer 1.

Preferably, the arrangement means 40 are adapted to arrange the control device 5 superficially resting on the attachment face 7.

Specifically, the arrangement means 40 and the positioning means 38 place the conductive body 3 and the control device 5 in the proximity to each other so as to define at least one RFID transponder 6.

Conveniently, the manufacturing system 36 comprises:
production means 30 of the tires 31 provided with machining means of at least one production body 33 for the production of at least one tire 31;
movement means 34 of the lattice layer 1 from the supporting means 37 to the production means 30.

Preferably, the term “lattice layer” employed with reference to the manufacturing system 36 is also intended to refer to any portion of the lattice layer 1, e.g. made by cutting the same.

Specifically, the movement means 34 are adapted to place the lattice layer 1 superficially resting on the production body 33.

For example, the movement means 34 are of the type of pick and place movement means.

Preferably, the production means 30 comprise at least one forming body 35 of the tire 31 around which, in use, the production body 33 is at least partly wrapped. Furthermore, the movement means 34 are adapted to position the lattice layer 1 resting on the production body 33 wrapped at least partly around the forming body 35.

In particular, the forming body 35 is adapted to give the production body 33 at least partly the conformation of the tire 31.

Advantageously, the movement means 34 are provided with at least one gripping body 28 movable between a gripping configuration, wherein it holds the lattice layer 1, allowing the movement thereof, and at least a release configuration, wherein it releases the lattice layer 1.

Preferably, the gripping body 28 is of the type of one or more clamps that grasp portions of the lattice layer 1.

According to the invention, the movement means 34 comprise a plurality of gripping bodies 28, each configured to attach to a corresponding portion of the lattice layer 1. In this way, the movement means 34 operate on a plurality of dots of the lattice layer 1, ensuring a firm grip.

In particular, the gripping bodies 28 are spaced apart from each other, preferably opposite each other, e.g. at the vertices or the sides of a rectangle.

Preferably, the movement means 34 comprise a base body 29 on which one or more gripping bodies 28 are mounted.

According to one possible embodiment of the manufacturing system 36, in the gripping configuration, the gripping body 28 passes through at least one of the meshes of the lattice layer 1, attaching thereto, and in the release configuration, the gripping body is moved away from the lattice layer 11 and arranged outside the meshes thereof, thus releasing it.

According to this embodiment, each of the gripping bodies 28 is configured to attach to a corresponding mesh of the lattice layer 1.

According to this embodiment, the gripping body 28 is movable in rotation around a central axis D to switch from the gripping configuration to the release configuration and vice versa.

Advantageously, the gripping body 28 has a substantially curved conformation and defines a loop that, in the gripping configuration, is arranged within a mesh of the lattice layer 1, holding and supporting it from below, as shown in FIG. 4.

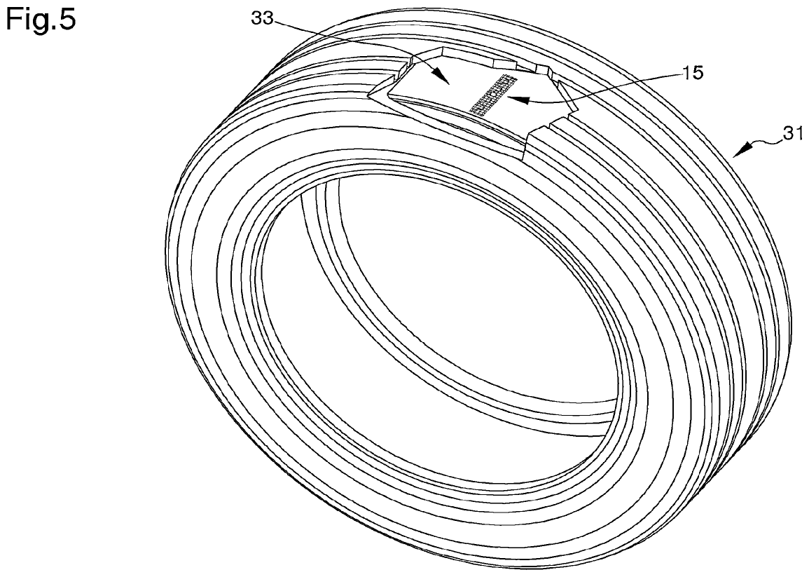

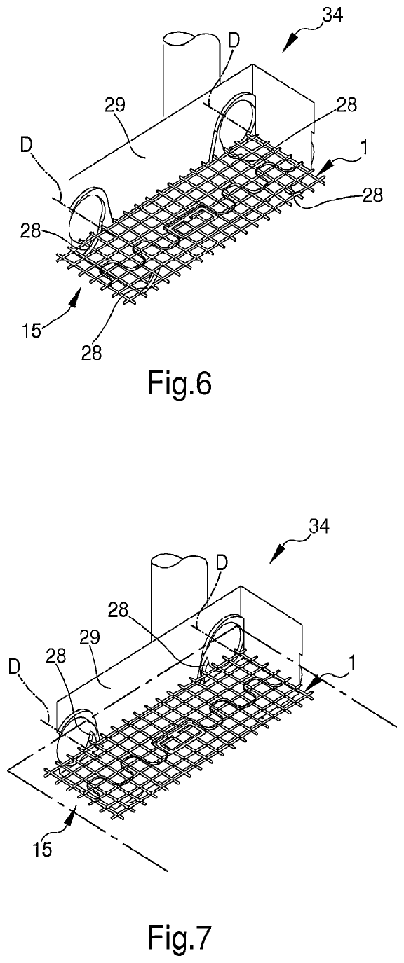

In the release configuration, on the other hand, the loop is arranged on top of the lattice layer 1, outside the meshes, releasing them, as shown in FIG. 5.

In more detail, in the switch from the release configuration to the gripping configuration, the gripping body 28 slips underneath the lattice layer 1 as it passes through one of the meshes.

In addition, in this way, the gripping body 28 lifts the lattice layer 1, which slides in contact with the gripping body 28, inside the loop.

According to the invention, the base body 29, in use, is arranged in the proximity to the lattice layer 1, preferably suspended on the same. Thus, in the switch from the release configuration to the gripping configuration, the gripping body 28 reaches the lattice layer 1, by grasping it.

Advantageously, the movement means 34 can replace those generally used to grasp the radio frequency devices provided with a solid (non-lattice) backing layer, e.g. suction members which, however, would not be adapted to grasp the lattice layer 1.

Conveniently, the manufacturing system 36 comprises at least a first supporting roller 17 on which the lattice layer 1 is wrapped, which defines at least one free end 20 moved along a direction of movement B.

Advantageously, the layer 1 is arranged, in use, taut along the direction of movement B, preferably by pulling or pushing the free end 20.

In addition, the positioning means 38 are configured to position a plurality of conductive bodies 3 on the attachment face 7 of the lattice layer 1 moved along the direction of movement B.

Conveniently, the arrangement means 40 are configured to arrange a plurality of control devices 5 on the attachment face 7 of the lattice layer 1 moved along the direction of movement B to define a plurality of RFID transponders 6.

Appropriately, at least one of the positioning means 38 or the arrangement means 40 are arranged along the direction of movement B.

Conveniently, the manufacturing system comprises testing means 23 arranged along the direction of movement B and configured to communicate inductively, remotely, with the RFID transponders 6 moved along the direction of movement B to check whether one or more RFID transponders 6 are defective or malfunctioning.

Specifically, the testing means 23 are configured to check whether one or more of the RFID transponders 6 transiting along the direction of movement B in the proximity thereof are defective or malfunctioning.

Preferably, the testing means 23 comprise at least one processing unit, not shown in the figures, configured to determine whether one or more of the RFID transponders meet one or more predefined parameters to determine whether they are defective or malfunctioning.

Advantageously, the manufacturing system 36 comprises cutting means 24 configured to cut the lattice layer 1 into a plurality of blocks 13, each carrying at least one of the RFID transponders 6.

Preferably, the cutting means 24 cut out the blocks 13 according to a predefined outline, e.g., prismatic with rectangular cross-section.

Conveniently, the movement means 34 are arranged along the line of movement B.

Preferably, the movement means 34 are arranged in succession to the cutting means 24 along the line of movement B.

Preferably, the movement means 34 operate directly on the lattice layer 1 to move it towards the production means 30, e.g., to position the lattice layer 1 superficially resting on the production body 33.

In this way, the lattice layer 1 is embedded into the production body 33 during the phase of production of the tire 31.

Further embodiments of the manufacturing system 36 cannot however be ruled out, wherein the lattice layer 1 is embedded into an embedding body 8 different from the tire 31 previously to the phase of production of the tire 31, as shown in FIG. 8.

In this embodiment, the manufacturing system 36 comprises:
at least a second and a third supporting rollers 18, 19 on which respective embedding layers 9a, 9b of the RFID transponders 6 are wrapped, defining respective free ends 20 and moved along the direction of movement B, so as to face the embedding layers 9a, 9b substantially on opposite sides of the lattice layer 1;
coupling means 21, arranged along said direction of movement B and adapted to couple the embedding layers 9a, 9b on opposite sides of the lattice layer 1 to embed the RFID transponders 6 within them.

For simplicity's sake, a lattice layer 1 on which a plurality of RFID transponders 6 have been arranged may be wrapped to the roller 17 in FIG. 8. It cannot however be ruled out that the lattice layer without the RFID transponders 6 may be wrapped around the roller 17 in FIG. 8, and that the system 36 in FIG. 8 may be provided with the positioning means 38, the forming means 39 and the arrangement means 40, e.g. arranged similarly to what is shown in FIG. 4, to make the RFID transponders 6 on the lattice layer 1.

Conveniently, the layers 1, 9a, 9b are moved along the direction of movement B by gradually unrolling them from their respective rollers 17, 18, 19.

Advantageously, the layers 1, 9a, 9b are arranged, in use, preferably taut along the direction of movement B, preferably by pulling or pushing the free ends 20.

Preferably, the rollers 17, 18, 19 rotate around respective axes of rotation C and lie on a common plane of lying substantially orthogonal to the axes of rotation C.

According to the invention, the rollers 17, 18, 19 are placed side by side, and preferably the first roller 17 is arranged between the second and the third roller 18, 19, as shown in FIG. 8.

Preferably, the coupling means 21 comprise at least one pressing assembly 22 configured to press under pressure at least one of the embedding layers 9a, 9b onto the lattice layer 1.

According to the invention, the pressing assembly 22 is of the type of a pressing roller adapted to rotate in contact with one of the embedding layers 9a, 9b by pressing it against the lattice layer 1.

Preferably, the manufacturing system 36 comprises a pair of pressing assemblies 22, opposite each other and each operating on a corresponding embedding layer 9a, 9b. In this way, the coupling means 21 press under pressure each embedding layer 9a, 9b on one side of the lattice layer 1 to embed one or more RFID transponders 6.

The possibility cannot however be ruled out that the manufacturing system may comprise a tabletop on which one of the embedding layers 9a, 9b rests, and an individual pressing assembly 22 operating on the other embedding layer 9a, 9b.

Advantageously, the cutting means 24 are arranged along the direction of movement B, subsequently to the coupling means 21.

In particular, the cutting means 24 are configured to cut, preferably orthogonally to the direction of development A, the layers 1, 9a, 9b starting from one embedding layer 9a, 9b as far as reaching the other.

In other words, the cutting means 24 are configured to cut out from the layers 1, 9a, 9b, stacked on top of each other, a plurality of blocks 13, each comprising a portion 11, 12 of each layer 1, 9a, 9b, as shown in FIG. 4.

Preferably, the cutting means 24 cut out the blocks 13 according to a predefined outline, e.g., prismatic with rectangular cross-section.

Advantageously, the portion of layers 1, 9a, 9b from which the blocks 13 have been cut out define a unique scrap 25.

In other words, the scrap 25 is substantially made in a single body piece.

Conveniently, the manufacturing system 36 comprises removal means of the scrap 25, not shown in the figures, configured to separate, preferably automatically, the scrap 25 from the blocks 13.

According to the invention, the testing means 23 and the cutting means 24 are operatively linked together. Thus, when one or more RFID transponders 6 are identified as defective or malfunctioning, the cutting means 24 do not cut the block 13 containing such RFID transponder, which consequently remains constrained to the scrap and thus removed by the removal means.

Advantageously, the cutting means 24 coincide with the coupling means 21.

In this embodiment, the movement means 34 operate on the block 13 layered by the layers 1, 9a, 9b.

Preferably, what is described about one or more of the components mentioned with reference to the manufacturing method of the radio frequency devices is also to be considered valid for one or more of the same components mentioned with reference to the manufacturing system 36.

According to a further aspect, the present invention relates to a production system 41 of tires 31 comprising the manufacturing system 36 previously described.

According to a further aspect, the present invention relates to a radio frequency device 15.

The radio frequency device 15 comprises:
at least one lattice layer 1 having lattice conformation and made of electrically insulating material;
at least one electronic control device 5 on the lattice layer 1;
at least one conductive body 3, made of electrically conductive material, having a substantially elongated conformation and arranged lying on the lattice layer 1, to make at least one antenna 4 having a predefined conformation and configured to be inductively coupled to the control device 5.

In addition, the conductive body 3 and the control device 5 are arranged in the proximity to each other to define an RFID transponder 6.

Preferably, the lattice layer 1 defines at least one attachment face 7.

In addition, the control device 5 is arranged to superficially rest on the attachment face 7.

In addition, the conductive body 3 is arranged to superficially rest on the attachment face 7.

Advantageously, the radio frequency device 15 comprises at least one embedding body 8, such as e.g. a product to be identified or a manufacturing material of the product itself, within which the RFID transponder 6 is embedded.

Specifically, the embedding body 8 passes through the lattice layer 1 to embed the RFID transponder 6.

Advantageously, the radio frequency device 15 is embedded within a tire 31.

Appropriately, the radio frequency device 15 comprises the tire 31.

Preferably, what is described with respect to one or more of the components mentioned with reference to the manufacturing method of the radio frequency devices and with reference to the manufacturing system 36 of the radio frequency devices 15 is also to be considered valid for one or more of the same components described 15 with respect to the radio frequency device 15.

Preferably, the radio frequency device 15 is manufactured by performing the manufacturing method described earlier in this disclosure and/or by using the manufacturing system 36 described earlier in this disclosure.

According to a further aspect, the present invention relates to a tire 31 comprising the radio frequency device 15.

Preferably, what is described with respect to one or more of the components mentioned with reference to the manufacturing method of the radio frequency devices 15, to the manufacturing system 36 of the radio frequency devices 15 and to the radio frequency device 15 is also to be considered valid for one or more of the same components described with respect to the tire 31.

Preferably, the tire 31 is manufactured by performing the manufacturing method described earlier in this disclosure and/or by using the manufacturing system 36 described earlier in this disclosure.

According to a further aspect, the present invention relates to a set 25 of radio frequency devices, comprising a plurality of radio frequency devices 15, wherein the plurality of radio frequency devices 15 share an individual lattice layer 1 on which a plurality of conductive bodies 3 and of control devices 5 is arranged to define a plurality of RFID transponders 6 arranged in succession on the same lattice layer 1.

Appropriately, according to a possible embodiment of the set 25, the plurality of radio frequency devices 15 share an individual embedding body 8, or an individual pair of embedding layers 9a, 9b.

Preferably, what is described with respect to one or more of the components mentioned with reference to the manufacturing method of the radio frequency devices 15, to the manufacturing system 36 of the radio frequency devices 15, to the radio frequency device 15 and to the tire 31 is also to be considered valid for one or more of the same components mentioned with reference to the tire 31.

Preferably, the set 25 is manufactured by performing the manufacturing method described earlier in this disclosure and/or by using the manufacturing system 36 described earlier in this disclosure.

It has in practice been ascertained that the described invention achieves the intended objects.

In particular, the fact is emphasized that the attachment of the antenna and of the control device to the lattice layer allows manufacturing radio frequency devices that are embeddable within a wide variety of target materials easily, conveniently and quickly.

In addition, this expedient makes it possible to manufacture radio frequency devices with particularly small overall dimensions compared with devices of known type.

In addition, the manufacturing system of the radio frequency device enables the latter to be easily, quickly and automatically moved, e.g., where a tire is located, during its production process. In this way, the manufacturing system is easily integrated into the production process of tires, which, consequently, are produced integrated with the radio frequency device, without varying the production processes of the tire itself.

1. Manufacturing method of radio frequency devices (15), comprising:
at least one phase of providing at least one lattice layer (1) having a lattice shape and made of electrically insulating material;
at least one phase of providing at least one electronic control device (5);
at least one phase of attaching said at least one control device (5) onto said lattice layer (1);
at least one phase of providing at least one conductive body (3), made of electrically conductive material;
at least one phase of attaching said at least one conductive body (3) substantially lying on said lattice layer (1) to make at least one antenna (4) having a predefined shape and configured to be inductively coupled to said control device (5);
said phase of attaching said at least one conductive body (3) and/or said phase of attaching said at least one control device (5) by arranging said at least one conductive body (3) and said at least one control device (5) in the proximity to each other to define at least one RFID transponder (6).

2. Method according to claim 1, characterized by the fact that:
said lattice layer (1) defines at least one attachment face (7);
said phase of attaching said control device (5) involves arranging the latter superficially resting on said attachment face (7);
said phase of attaching said conductive body (3) involves arranging the latter superficially resting on said attachment face (7).

3. Method according to claim 1, characterized by the fact that it comprises at least one phase of embedding said lattice layer (1) within an embedding body (8).

4. Method according to claim 1, characterized by the fact that said phase of embedding comprises at least the steps of:
providing at least one embedding layer (9a, 9b);
overlapping said embedding layer (9a, 9b) to said lattice layer (1).

5. Method according to claim 1, characterized by the fact that it comprises:
at least one phase of providing production means (30) of tires (31);
at least one phase of production of said at least one tire (31) through said production means (30).
said phase of embedding being carried out during said phase of production and said embedding body (8) coinciding with said at least one tire (31).

6. Method according to claim 1, characterized by the fact that:
said phase of production comprises at least one phase of providing at least one production body (33) to produce said at least one tire (31), said production means (30) comprising machining means of said production body (33) for the production of said at least one tire (31);
it comprises at least one phase of positioning said lattice layer (1) superficially resting on said production body (33) during said phase of production.

7. Method according to claim 1, characterized by the fact that said embedding layer (9a, 9b) coincides with said production body (33) and said overlapping step coincides with said phase of positioning.

8. Method according to claim 1, characterized by the fact that it comprises at least one phase of repeating said phase of providing at least one conductive body (3), of said phase of providing at least one control device (5), of said phase of attaching said at least one conductive body (3) and of said phase of attaching said at least one control device (5) to make a plurality of said RFID transponders (6) onto said lattice layer (1).

9. Method according to claim 1, characterized by the fact that it comprises at least one phase of wrapping said lattice layer (1) on itself on which said RFID transponders (6) are made.

10. Method according to claim 1, characterized by the fact that it comprises at least one phase of cutting said lattice layer (1), said phase of cutting dividing said lattice layer (1) into a plurality of separate lattice portions (11), each of which supporting at least one RFID transponder (6).

11. Manufacturing system (36) of radio frequency devices (15), comprising:
supporting means (37) for supporting at least one lattice layer (1), made of electrically insulating material;
positioning means (38) for positioning at least one conductive body (3) substantially lying on said lattice layer (1) to make at least one antenna (4) having predefined conformation, said conductive body (3) being made of electrically conductive material.

12. Manufacturing system (36) according to claim 11, characterized by the fact that it comprises forming means (39), operating on said conductive body (3) to deform it and give it the predefined conformation.

13. Manufacturing system (36) according to claim 11, characterized by the fact that said forming means (39) coincide with said positioning means (38).

14. Manufacturing system (36) according to claim 11, characterized by the fact that it comprises arrangement means (40) of at least one control device (5) on said lattice layer (1), said arrangement means (40) and said positioning means (38) arranging said at least one conductive body (3) and said at least one control device (5) in the proximity to each other to define at least one RFID transponder (6).

15. Manufacturing system (36) according to claim 11, characterized by the fact that it comprises:
production means (30) of the tires (31) provided with machining means of at least one production body (33) for the production of at least one tire (31);
movement means (34) of said lattice layer (1) from said supporting means (37) to said production means (30), said movement means (34) being adapted to place said lattice layer (1) superficially resting on said production body (33).

16. Radio frequency device (15), comprising:
at least one lattice layer (1) having lattice conformation and made of electrically insulating material;
at least one electronic control device (5) arranged on said lattice layer (1);
at least one conductive body (3), made of electrically conductive material and arranged lying on said lattice layer (1), to make at least one antenna (4) having a predefined conformation and configured to be inductively coupled to said control device (5);
said at least one conductive body (3) and said at least one control device (5) being arranged in close proximity to each other to define an RFID transponder (6).

17. Radio frequency device (15) according to claim 16, characterized by the fact that:
said lattice layer (1) defines at least one attachment face (7);
said control device (5) is arranged superficially resting on said attachment face (7);
said conductive body (3) is arranged superficially resting on said attachment face (7).

18. Radio frequency device (15) according to claim 16, characterized by the fact that said control device (5) comprises:
at least one control microchip (5a);
at least one control antenna (5b) operatively connected to said control microchip (5a), said antenna (4) being configured to be inductively coupled to said control antenna (4b);
at least one protective enclosure (10), containing at least one of said control microchip (5a) or said control antenna (5b), at least one of said enclosure (10), said control microchip (5a) and/or said control antenna (5b) being substantially shaped in a loop bounding a substantially free inner section.

19. Set (25) of radio frequency devices (15), comprising a plurality of radio frequency devices (15) according to claim 16, wherein the plurality of said radio frequency devices (15) share an individual lattice layer (1) on which a plurality of said conductive bodies (3) and of said control devices (5) is arranged to define a plurality of said RFID transponders (6) arranged in succession on the same lattice layer (1).

20. Tire (31), comprising said radio frequency device (15), according to claim 16.
